(19) United States
(12) Patent Application Publication
(10) Pub. No.: US 2025/0190969 A1
(43) Pub. Date: Jun. 12, 2025

(54) System, Method, and Computer Program Product for Flexible Transaction Message Routing

(71) Applicant: Visa International Service Association, San Francisco, CA (US)

(72) Inventors: Conor John Lynch, Singapore (SG); Christopher Joseph Bishop, Shibuya-ku (JP); Karthikeyan Palanisamy, Singapore (SG); Emily Chang, Flower Mound, TX (US); C. William Byrne, III, Portland, OR (US); Kaori Hirakawa, Yokohama-shi (JP); Abhishek Verma, Highlands Ranch, CO (US); Shipra Jha, Fremont, CA (US)

(21) Appl. No.: 18/843,979

(22) PCT Filed: Mar. 31, 2023
(86) PCT No.: PCT/US2023/017153

§ 371 Date: Sep. 4, 2024

(51) Int. Cl. G06Q 20/22; G06Q 20/38; G06Q 20/40

(52) U.S. Cl. CPC G06Q 20/227; G06Q 20/389; G06Q 20/405

(57) ABSTRACT

Systems, methods, and computer program products are provided for flexible transaction message routing. An exemplary method includes receiving an authorization request message associated with a payment transaction. The authorization request message includes a first account identifier associated with a user. A second account identifier is determined from a plurality of account identifiers based on at least one rule associated with the first account identifier. A modified authorization request message for the payment transaction is generated. The modified authorization request message includes the second account identifier. The modified authorization request message is transmitted to an issuer system associated with the second account identifier. A transaction history record based on the payment transaction and the second account identifier is stored.

### CROSS REFERENCE TO RELATED APPLICATIONS

This application is the United States national phase of International Patent Application No. PCT/US23/17153 filed on Mar. 31, 2023, and claims the benefit of U.S. Provisional Patent Application No. 63/330,987 filed on Apr. 14, 2022, the disclosures of which are hereby incorporated by reference in their entireties.

### BACKGROUND

### 1. Technical Field

This disclosure relates generally to transaction message routing, and in some non-limiting embodiments or aspects, systems, methods, and computer program products for flexible transaction message routing.

### 2. Technical Considerations

Electronic payment processing systems may use an account identifier to initiate and/or settle a transaction. For example, a payment transaction may be initiated with a credit card number (e.g., primary account number (PAN)) at a merchant system, and the same credit card number may be used to settle that transaction at a later time. In such systems, each payment device (e.g., a credit card, a debit card, a prepaid card, etc.) may have a single account number (e.g., PAN) associated therewith.

However, such systems may require a user to physically select a different payment device (or remember to type in the account identifier of a different payment device) in order to use a different account for different types of transactions. As such, the user may be required to carry multiple different payment devices and/or memorize different account identifiers. Moreover, these electronic payment processing systems do not allow a user to substitute a different account and/or different account type (e.g. debit card account, credit card account, pre-paid card account, etc.) once the payment transaction is initiated with a certain payment device. Additionally, these payment processing systems do not allow a transaction to be settled with a different account and/or account type than the account associated with the payment device used to initiate a transaction. This poses difficulty in situations where a settlement process of the payment transaction is denied or hindered for unknown reasons.

### SUMMARY

Accordingly, provided are improved systems, methods, and computer program products for flexible transaction message routing that overcome some or all of the deficiencies identified above.

According to non-limiting embodiments or aspects, provided is a computer-implemented method for flexible transaction message routing. An example method may include receiving, with at least one processor, an authorization request message associated with a payment transaction. The authorization request message may include a first account identifier associated with a user. The method may include determining, with at least one processor, a second account identifier from a plurality of account identifiers based on at least one rule associated with the first account identifier. The method may include generating, with at least one processor, a modified authorization request message for the payment transaction. The modified authorization request message may include the second account identifier. The method may include transmitting, with at least one processor, the modified authorization request message to an issuer system associated with the second account identifier. The method may include storing, with at least one processor, a transaction history record based on the payment transaction and the second account identifier.

In some non-limiting embodiments or aspects, the method may further include receiving, with at least one processor, rule data associated with the at least one rule. The rule data may include a threshold value. The method may include determining, with at least one processor, whether a transaction amount of the payment transaction satisfies the threshold value. Determining the second account identifier may include selecting the second account identifier from the plurality of account identifiers based on the transaction amount satisfying the threshold value.

In some non-limiting embodiments or aspects, the at least one rule may include a first rule based on rule data received from the user and a fallback rule. Determining the second account identifier may include determining, with at least one processor, the first rule is not applicable to the payment transaction associated with the authorization request message and, in response to determining that the first rule is not applicable, determining, with at least one processor, the second account identifier from the plurality of account identifiers based on the fallback rule.

In some non-limiting embodiments or aspects, the method may further include receiving, with at least one processor, a settlement request message associated with the payment transaction. The settlement request message may include the first account identifier. The method may include identifying, with at least one processor, the transaction history record based on the payment transaction. The method may include generating, with at least one processor, a modified settlement request message based on identifying the transaction history record. The modified settlement request message may include the second account identifier. The method may include transmitting, with at least one processor, the modified settlement request message to the issuer system associated with the second account identifier.

In some non-limiting embodiments or aspects, the method may further include receiving, with at least one processor, a settlement request message associated with a second payment transaction. The settlement request message may include the first account identifier. The method may include determining, with at least one processor, a second transaction history associated with the second payment transaction is not stored. The method may include, in response to determining the second transaction history is not stored, applying, with at least one processor, a fallback settlement rule.

In some non-limiting embodiments or aspects, the method may further include receiving, with at least one processor, rule data associated with the at least one rule from the issuer system.

In some non-limiting embodiments or aspects, the first account identifier may include a lead account identifier associated with a physical payment device associated with the user. The plurality of account identifiers may include a plurality of virtual account identifiers associated with the user. The second account identifier may include a selected virtual account identifier. Determining the second account identifier may include selecting the selected virtual account identifier from the plurality of virtual account identifiers based on the at least one rule.

In some non-limiting embodiments or aspects, the lead account identifier may include a debit account identifier. The plurality of virtual account identifiers may include a virtual credit account identifier and a virtual prepaid account identifier.

According to non-limiting embodiments or aspects, provided is a system for flexible transaction message routing. An example system may include at least one processor and at least one non-transitory computer-readable medium storing instructions. When executed by the at least one processor, the instructions may cause the at least one processor to receive an authorization request message associated with a payment transaction. The authorization request message may include a first account identifier associated with a user. When executed by the at least one processor, the instructions may cause the at least one processor to determine a second account identifier from a plurality of account identifiers based on at least one rule associated with the first account identifier. When executed by the at least one processor, the instructions may cause the at least one processor to generate a modified authorization request message for the payment transaction. The modified authorization request message may include the second account identifier. When executed by the at least one processor, the instructions may cause the at least one processor to transmit the modified authorization request message to an issuer system associated with the second account identifier. When executed by the at least one processor, the instructions may cause the at least one processor to store a transaction history record based on the payment transaction and the second account identifier.

In some non-limiting embodiments or aspects, the instructions, when executed by the at least one processor, may further cause the at least one processor to receive rule data associated with the at least one rule. The rule data may include a threshold value and/or determine whether a transaction amount of the payment transaction satisfies the threshold value. Determining the second account identifier may include selecting the second account identifier from the plurality of account identifiers based on the transaction amount satisfying the threshold value.

In some non-limiting embodiments or aspects, the at least one rule may include a first rule based on rule data received from the user and a fallback rule. Determining the second account identifier may include determining the first rule is not applicable to the payment transaction associated with the authorization request message and/or, in response to determining that the first rule is not applicable, determining the second account identifier from the plurality of account identifiers based on the fallback rule.

In some non-limiting embodiments or aspects, the instructions, when executed by the at least one processor, may further cause the at least one processor to receive a settlement request message associated with the payment transaction. The settlement request message may include the first account identifier. When executed by the at least one processor, the instructions may cause the at least one processor to identify the transaction history record based on the payment transaction. When executed by the at least one processor, the instructions may cause the at least one processor to generate a modified settlement request message based on identifying the transaction history record. The modified settlement request message may include the second account identifier. When executed by the at least one processor, the instructions may cause the at least one processor to transmit the modified settlement request message to the issuer system associated with the second account identifier.

In some non-limiting embodiments or aspects, the instructions, when executed by the at least one processor, may further cause the at least one processor to receive a settlement request message associated with a second payment transaction. The settlement request message may include the first account identifier. When executed by the at least one processor, the instructions may cause the at least one processor to determine a second transaction history associated with the second payment transaction is not stored. When executed by the at least one processor, the instructions may cause the at least one processor to, in response to determining the second transaction history is not stored, apply a fallback settlement rule.

In some non-limiting embodiments or aspects, the instructions, when executed by the at least one processor, may further cause the at least one processor to receive rule data associated with the at least one rule from the issuer system.

In some non-limiting embodiments or aspects, the first account identifier may include a lead account identifier associated with a physical payment device associated with the user. The plurality of account identifiers may include a plurality of virtual account identifiers associated with the user. The second account identifier may include a selected virtual account identifier. Determining the second account identifier may include selecting the selected virtual account identifier from the plurality of virtual account identifiers based on the at least one rule.

In some non-limiting embodiments or aspects, the lead account identifier may include a debit account identifier. The plurality of virtual account identifiers may include a virtual credit account identifier and a virtual prepaid account identifier.

According to non-limiting embodiments or aspects, provided is a computer program product for flexible transaction message routing. An example computer program product may include at least one non-transitory computer-readable medium including program instructions that, when executed by at least one processor, cause the at least one processor to receive an authorization request message associated with a payment transaction. The authorization request message may include a first account identifier associated with a user. When executed by the at least one processor, the instructions may cause the at least one processor to determine a second account identifier from a plurality of account identifiers based on at least one rule associated with the first account identifier. When executed by the at least one processor, the instructions may cause the at least one processor to generate a modified authorization request message for the payment transaction. The modified authorization request message may include the second account identifier. When executed by the at least one processor, the instructions may cause the at least one processor to transmit the modified authorization request message to an issuer system associated with the second account identifier. When executed by the at least one processor, the instructions may cause the at least one processor to store a transaction history record based on the payment transaction and the second account identifier.

In some non-limiting embodiments or aspects, the instructions, when executed by the at least one processor, may further cause the at least one processor to receive rule data associated with the at least one rule. The rule data may include a threshold value and/or determine whether a transaction amount of the payment transaction satisfies the threshold value. Determining the second account identifier may include selecting the second account identifier from the plurality of account identifiers based on the transaction amount satisfying the threshold value.

In some non-limiting embodiments or aspects, the at least one rule may include a first rule based on rule data received from the user and a fallback rule. Determining the second account identifier may include determining the first rule is not applicable to the payment transaction associated with the authorization request message and/or, in response to determining that the first rule is not applicable, determining the second account identifier from the plurality of account identifiers based on the fallback rule.

In some non-limiting embodiments or aspects, the instructions, when executed by the at least one processor, may further cause the at least one processor to receive a settlement request message associated with the payment transaction. The settlement request message may include the first account identifier. When executed by the at least one processor, the instructions may cause the at least one processor to identify the transaction history record based on the payment transaction. When executed by the at least one processor, the instructions may cause the at least one processor to generate a modified settlement request message based on identifying the transaction history record. The modified settlement request message may include the second account identifier. When executed by the at least one processor, the instructions may cause the at least one processor to transmit the modified settlement request message to the issuer system associated with the second account identifier.

In some non-limiting embodiments or aspects, the instructions, when executed by the at least one processor, may further cause the at least one processor to receive a settlement request message associated with a second payment transaction. The settlement request message may include the first account identifier. When executed by the at least one processor, the instructions may cause the at least one processor to determine a second transaction history associated with the second payment transaction is not stored. When executed by the at least one processor, the instructions may cause the at least one processor to, in response to determining the second transaction history is not stored, apply a fallback settlement rule.

In some non-limiting embodiments or aspects, the instructions, when executed by the at least one processor, may further cause the at least one processor to receive rule data associated with the at least one rule from the issuer system.

In some non-limiting embodiments or aspects, the first account identifier may include a lead account identifier associated with a physical payment device associated with the user. The plurality of account identifiers may include a plurality of virtual account identifiers associated with the user. The second account identifier may include a selected virtual account identifier. Determining the second account identifier may include selecting the selected virtual account identifier from the plurality of virtual account identifiers based on the at least one rule.

In some non-limiting embodiments or aspects, the lead account identifier may include a debit account identifier. The plurality of virtual account identifiers may include a virtual credit account identifier and a virtual prepaid account identifier.

Other non-limiting embodiments or aspects will be set forth in the following numbered clauses:
Clause 1: A computer-implemented method, comprising: receiving, with at least one processor, an authorization request message associated with a payment transaction, the authorization request message comprising a first account identifier associated with a user; determining, with at least one processor, a second account identifier from a plurality of account identifiers based on at least one rule associated with the first account identifier; generating, with at least one processor, a modified authorization request message for the payment transaction, the modified authorization request message comprising the second account identifier; transmitting, with at least one processor, the modified authorization request message to an issuer system associated with the second account identifier; and storing, with at least one processor, a transaction history record based on the payment transaction and the second account identifier.
Clause 2: The method of clause 1, further comprising: receiving, with at least one processor, rule data associated with the at least one rule, wherein the rule data comprises a threshold value; and determining, with at least one processor, whether a transaction amount of the payment transaction satisfies the threshold value, wherein determining the second account identifier comprises selecting the second account identifier from the plurality of account identifiers based on the transaction amount satisfying the threshold value.
Clause 3: The method of clause 1 or 2, wherein the at least one rule comprises a first rule based on rule data received from the user and a fallback rule, wherein determining the second account identifier comprises: determining, with at least one processor, the first rule is not applicable to the payment transaction associated with the authorization request message; and in response to determining that the first rule is not applicable, determining, with at least one processor, the second account identifier from the plurality of account identifiers based on the fallback rule.
Clause 4: The method of any of clauses 1-3, further comprising: receiving, with at least one processor, a settlement request message associated with the payment transaction, the settlement request message comprising the first account identifier; identifying, with at least one processor, the transaction history record based on the payment transaction; generating, with at least one processor, a modified settlement request message based on identifying the transaction history record, the modified settlement request message comprising the second account identifier; and transmitting, with at least one processor, the modified settlement request message to the issuer system associated with the second account identifier.
Clause 5: The method of any of clauses 1-4, further comprising: receiving, with at least one processor, a settlement request message associated with a second payment transaction, the settlement request message comprising the first account identifier; determining, with at least one processor, a second transaction history associated with the second payment transaction is not stored; and in response to determining the second transaction history is not stored, applying, with at least one processor, a fallback settlement rule.
Clause 6: The method of any of clauses 1-5, further comprising: receiving, with at least one processor, rule data associated with the at least one rule from the issuer system.
Clause 7: The method of any of clauses 1-6, wherein the first account identifier comprises a lead account identifier associated with a physical payment device associated with the user, wherein the plurality of account identifiers comprises a plurality of virtual account identifiers associated with the user, wherein the second account identifier comprises a selected virtual account identifier, and wherein determining the second account identifier comprises selecting the selected virtual account identifier from the plurality of virtual account identifiers based on the at least one rule.
Clause 8: The method of any of clauses 1-7, wherein the lead account identifier comprises a debit account identifier, and wherein the plurality of virtual account identifiers comprises a virtual credit account identifier and a virtual prepaid account identifier.
Clause 9: A system comprising: at least one processor; and at least one non-transitory computer-readable medium storing instructions that, when executed by the at least one processor, cause the at least one processor to: receive an authorization request message associated with a payment transaction, the authorization request message comprising a first account identifier associated with a user; determine a second account identifier from a plurality of account identifiers based on at least one rule associated with the first account identifier; generate a modified authorization request message for the payment transaction, the modified authorization request message comprising the second account identifier; transmit the modified authorization request message to an issuer system associated with the second account identifier; and store a transaction history record based on the payment transaction and the second account identifier.
Clause 10: The system of clause 9, wherein the instructions, when executed by the at least one processor, further cause the at least one processor to: receive rule data associated with the at least one rule, wherein the rule data comprises a threshold value; and determine whether a transaction amount of the payment transaction satisfies the threshold value, wherein determining the second account identifier comprises selecting the second account identifier from the plurality of account identifiers based on the transaction amount satisfying the threshold value.
Clause 11: The system of clause 9 or clause 10, wherein the at least one rule comprises a first rule based on rule data received from the user and a fallback rule, wherein determining the second account identifier comprises: determining the first rule is not applicable to the payment transaction associated with the authorization request message; and in response to determining that the first rule is not applicable, determining the second account identifier from the plurality of account identifiers based on the fallback rule.
Clause 12: The system of any of clauses 9-11, wherein the instructions, when executed by the at least one processor, further cause the at least one processor to: receive a settlement request message associated with the payment transaction, the settlement request message comprising the first account identifier; identify the transaction history record based on the payment transaction; generate a modified settlement request message based on identifying the transaction history record, the modified settlement request message comprising the second account identifier; and transmit the modified settlement request message to the issuer system associated with the second account identifier.
Clause 13: The system of any of clauses 9-12, wherein the instructions, when executed by the at least one processor, further cause the at least one processor to: receive a settlement request message associated with a second payment transaction, the settlement request message comprising the first account identifier; determine a second transaction history associated with the second payment transaction is not stored; and in response to determining the second transaction history is not stored, apply a fallback settlement rule.
Clause 14: The system of any of clauses 9-13, wherein the instructions, when executed by the at least one processor, further cause the at least one processor to: receive rule data associated with the at least one rule from the issuer system.
Clause 15: The system of any of clauses 9-14, wherein the first account identifier comprises a lead account identifier associated with a physical payment device associated with the user, wherein the plurality of account identifiers comprises a plurality of virtual account identifiers associated with the user, wherein the second account identifier comprises a selected virtual account identifier, and wherein determining the second account identifier comprises selecting the selected virtual account identifier from the plurality of virtual account identifiers based on the at least one rule.
Clause 16: The system of any of clauses 9-15, wherein the lead account identifier comprises a debit account identifier, and wherein the plurality of virtual account identifiers comprises a virtual credit account identifier and a virtual prepaid account identifier.
Clause 17: A computer program product comprising at least one non-transitory computer-readable medium including program instructions that, when executed by at least one processor, cause the at least one processor to: receive an authorization request message associated with a payment transaction, the authorization request message comprising a first account identifier associated with a user; determine a second account identifier from a plurality of account identifiers based on at least one rule associated with the first account identifier; generate a modified authorization request message for the payment transaction, the modified authorization request message comprising the second account identifier; transmit the modified authorization request message to an issuer system associated with the second account identifier; and store a transaction history record based on the payment transaction and the second account identifier.
Clause 18: The computer program product of clause 17, wherein the instructions, when executed by the at least one processor, further cause the at least one processor to: receive rule data associated with the at least one rule, wherein the rule data comprises a threshold value; and determine whether a transaction amount of the payment transaction satisfies the threshold value, wherein determining the second account identifier comprises selecting the second account identifier from the plurality of account identifiers based on the transaction amount satisfying the threshold value.
Clause 19: The computer program product of clause 17 or clause 18, wherein the at least one rule comprises a first rule based on rule data received from the user and a fallback rule, wherein determining the second account identifier comprises: determining the first rule is not applicable to the payment transaction associated with the authorization request message; and in response to determining that the first rule is not applicable, determining the second account identifier from the plurality of account identifiers based on the fallback rule.
Clause 20: The computer program product of any of clauses 17-19, wherein the instructions, when executed by the at least one processor, further cause the at least one processor to: receive a settlement request message associated with the payment transaction, the settlement request message comprising the first account identifier; identify the transaction history record based on the payment transaction; generate a modified settlement request message based on identifying the transaction history record, the modified settlement request message comprising the second account identifier; and transmit the modified settlement request message to the issuer system associated with the second account identifier.
Clause 21: The computer program product of any of clauses 17-20, wherein the instructions, when executed by the at least one processor, further cause the at least one processor to: receive a settlement request message associated with a second payment transaction, the settlement request message comprising the first account identifier; determine a second transaction history associated with the second payment transaction is not stored; and in response to determining the second transaction history is not stored, apply a fallback settlement rule.
Clause 22: The computer program product of any of clauses 17-21, wherein the instructions, when executed by the at least one processor, further cause the at least one processor to: receive rule data associated with the at least one rule from the issuer system.
Clause 23: The computer program product of any of clauses 17-22, wherein the first account identifier comprises a lead account identifier associated with a physical payment device associated with the user, wherein the plurality of account identifiers comprises a plurality of virtual account identifiers associated with the user, wherein the second account identifier comprises a selected virtual account identifier, and wherein determining the second account identifier comprises selecting the selected virtual account identifier from the plurality of virtual account identifiers based on the at least one rule.
Clause 24: The computer program product of any of clauses 17-23, wherein the lead account identifier comprises a debit account identifier, and wherein the plurality of virtual account identifiers comprises a virtual credit account identifier and a virtual prepaid account identifier.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for flexible transaction message routing according to some non-limiting embodiments or aspects;

FIG. 2 is a flow diagram for a method for flexible transaction message routing according to some non-limiting embodiments or aspects;

FIG. 3 is a diagram of an exemplary environment in which methods, systems, and/or computer program products, described herein, may be implemented according to some non-limiting embodiments or aspects;

FIG. 4 is a schematic diagram of example components of one or more devices of FIG. 1 and/or FIG. 3 according to some non-limiting embodiments or aspects;

FIGS. 5A and 5B are schematic diagrams of an implementation of systems and methods for flexible transaction message routing according to some non-limiting embodiments or aspects; and

FIGS. 6A and 6B are schematic diagrams of an implementation of systems and methods for flexible transaction message routing according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second units. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Pay®, Android Pay®, Apple Pay®, Samsung Pay®, and/or other like electronic payment systems. In some non-limiting examples, an issuer bank may be an electronic wallet provider.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications. A “point-of-sale (POS) system,” as used herein, may refer to one or more computers and/or peripheral devices used by a merchant to engage in payment transactions with customers, including one or more card readers, near-field communication (NFC) receivers, RFID receivers, and/or other contactless transceivers or receivers, contact-based receivers, payment terminals, computers, servers, input devices, and/or other like devices that can be used to initiate a payment transaction.

As used herein, the term “payment device” may refer to an electronic payment device, a portable financial device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a personal digital assistant (PDA), a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Non-limiting embodiments or aspects of the disclosed subject matter are directed to systems, methods, and computer program products for flexible transaction message routing. For example, non-limiting embodiments or aspects of the disclosed subject matter provide receiving an authorization request message associated with a payment transaction. The authorization request message may include a first account identifier (e.g., an identifier of the flex account) associated with a user. A second account identifier (e.g., an identifier of an account, separate from the flex account) from a plurality of account identifiers may be determined. This determination may occur via a rule. The rule may be set by the user or be pre-set. After such determination, a modified authorization request message for the payment transaction may be generated where the modified authorization request message have include the second account identifier. This modified authorization request message may be transmitted to other systems, such as the issuer system, for further processing. Then, a transaction history record based on the payment transaction involving the first account identifier and the second account identifier may be stored. After a transaction has been authorized, a settlement request message associated with the payment transaction may be generated and received. The settlement request message may include the first account identifier. Based on the transaction history record, a modified settlement request message may be generated, and the modified settlement request message may include the second account identifier. Then, the modified settlement request message may be transmitted to other systems, such as the issuer system, for further processing. As such, the disclosed subject matter enables one or more transactions to be initiated with a single account identifier (e.g., of the flex account) and have a different account and/or account type to be used to authorize and then settle the transaction. Additionally, the disclosed subject matter allows a user to complete transactions using a plurality of different accounts and/or account types while only needing to carry and/or type in a single account identifier. Moreover, the disclosed subject matter enables the user to set customized rules for selection of which account and/or account type is used for different transactions (e.g., based on customizable criteria). Furthermore, the disclosed subject matter ensures that the same account is used for settlement of the transaction as was used for authorization of the transaction even though the (second) account identifier used to complete the authorization is different than the (first) account identifier in the settlement message due to the storage of the transaction history.

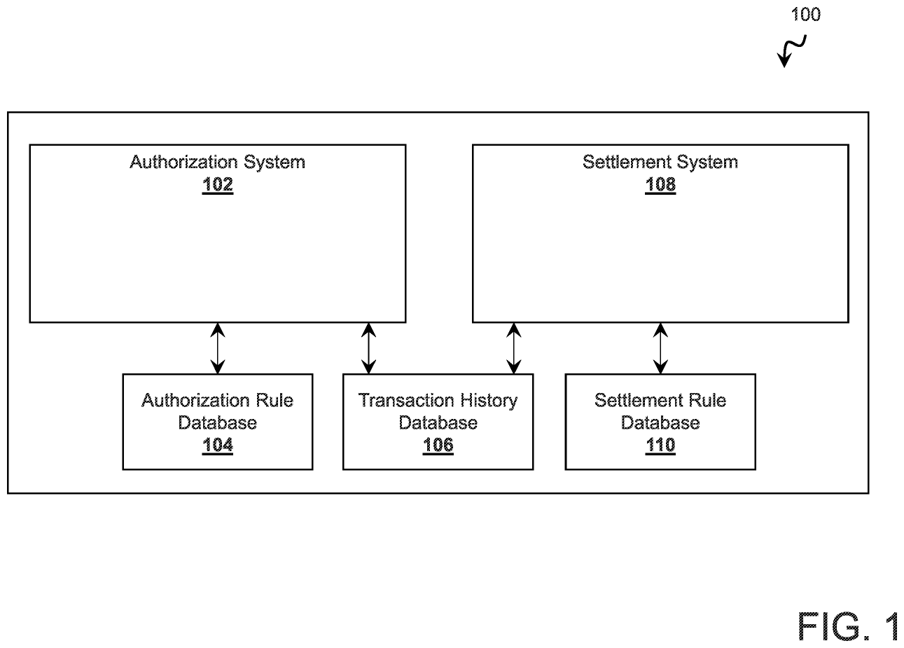

FIG. 1 depicts a system 100 for flexible transaction message routing according to non-limiting embodiments or aspects. The system 100 may include authorization system 102, authorization rule database 104, transaction history database 106, settlement system 108, and/or settlement rule database 110.

Authorization system 102 may include one or more devices capable of receiving information from and/or communicating information to authorization rule database 104, transaction history database 106, an acquirer system, a payment gateway system, and/or an issuer system. For example, authorization system 102 may include a computing device, such as a server, a group of servers, and/or other like devices. In some non-limiting embodiments or aspects, authorization system 102 may receive authorization requests, e.g., from acquirer systems and/or a payment gateway systems, as described herein. Additionally or alternatively, authorization system 102 may communicate authorization requests, e.g., to issuer systems, as described herein. In some non-limiting embodiments or aspects, authorization system 102 may receive authorization responses, e.g., from issuer systems, as described herein. Additionally or alternatively, authorization system 102 may communicate authorization responses, e.g., to acquirer systems and/or a payment gateway systems, as described herein.

Authorization rule database 104 may include one or more devices capable of receiving information from and/or communicating information to authorization system 102, an issuer system, and/or a customer device. For example, authorization rule database 104 may include a computing device, such as a server, a group of servers, and/or other like devices. In some non-limiting embodiments or aspects, authorization rule database 104 may be in communication with a data storage device, which may be local or remote to authorization rule database 104. In some non-limiting embodiments or aspects, authorization rule database 104 may be capable of receiving information from, storing information in, communicating information to, or searching information stored in the data storage device.

Transaction history database 106 may include one or more devices capable of receiving information from and/or communicating information to authorization system 102 and/or settlement system 108. For example, transaction history database 106 may include a computing device, such as a server, a group of servers, and/or other like devices. In some non-limiting embodiments or aspects, transaction history database 106 may be in communication with a data storage device, which may be local or remote to transaction history database 106. In some non-limiting embodiments or aspects, transaction history database 106 may be capable of receiving information from, storing information in, communicating information to, or searching information stored in the data storage device.

Settlement system 108 may include one or more devices capable of receiving information from and/or communicating information to transaction history database 106, settlement rule database 110, an acquirer system, a payment gateway system, and/or an issuer system. For example, settlement system 108 may include a computing device, such as a server, a group of servers, and/or other like devices. In some non-limiting embodiments or aspects, settlement system 108 may receive settlement requests, e.g., from acquirer systems and/or a payment gateway systems, as described herein. Additionally or alternatively, settlement system 108 may communicate settlement requests, e.g., to issuer systems, as described herein. In some non-limiting embodiments or aspects, settlement system 108 may receive settlement responses, e.g., from issuer systems, as described herein. Additionally or alternatively, settlement system 108 may communicate settlement responses, e.g., to acquirer systems and/or a payment gateway systems, as described herein.

Settlement rule database 110 may include one or more devices capable of receiving information from and/or communicating information to settlement system 108. For example, settlement rule database 110 may include a computing device, such as a server, a group of servers, and/or other like devices. In some non-limiting embodiments or aspects, settlement rule database 110 may be in communication with a data storage device, which may be local or remote to settlement rule database 110. In some non-limiting embodiments or aspects, settlement rule database 110 may be capable of receiving information from, storing information in, communicating information to, or searching information stored in the data storage device.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 100 may perform one or more functions described as being performed by another set of systems or another set of devices of system 100.

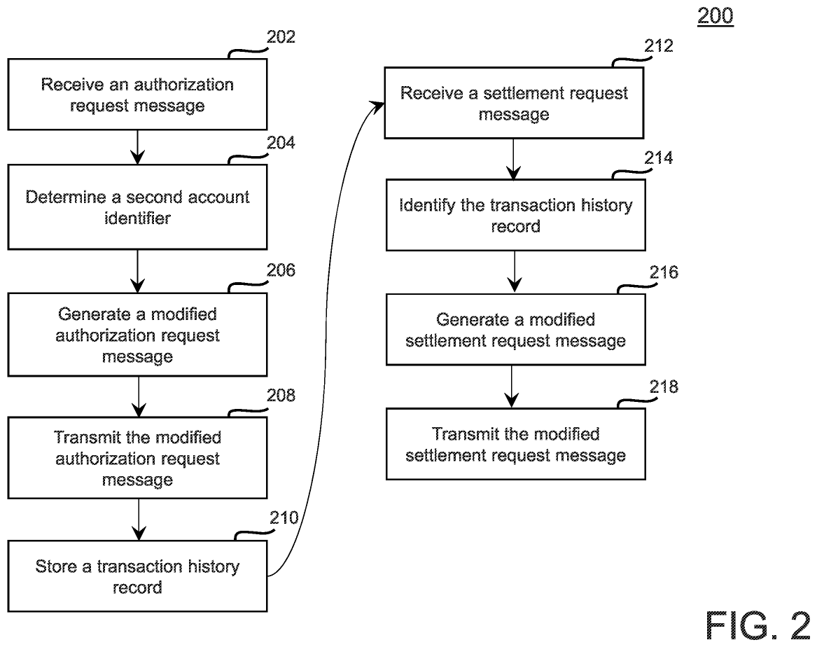

Referring now to FIG. 2, shown is a process 200 for flexible transaction message routing according to some non-limiting embodiments or aspects. The steps shown in FIG. 2 are for example purposes only. It will be appreciated that additional, fewer, different, and/or different order of steps may be used in non-limiting embodiments or aspects.

As shown in FIG. 2, at step 202, process 200 may include receiving an authorization request message. In some non-limiting embodiments or aspects, system 100 (e.g., authorization system 102 thereof) may receive an authorization request message associated with a payment transaction between a user and a merchant. For example, authorization system 102 may receive the authorization request message associated with the payment transaction between the user and the merchant. The authorization request message may include a first account identifier associated with the user. The first account identifier may be associated with a first account (e.g., a flex account) that may be associated with a plurality of other types of accounts. In some non-limiting embodiments or aspects, the transaction data may be received from an acquirer system and/or a payment gateway system. For example, authorization system 102 may receive the authorization request message from an acquirer system, as described herein. In some non-limiting embodiments or aspects, the authorization request may include other identifying information associated with the payment transaction, such as a transaction identifier, a timestamp, a merchant identifier, a merchant account identifier, any combination thereof, and/or the like.

In some non-limiting embodiments or aspects, the first account identifier may include a lead account identifier associated with a physical payment device associated with the user. Additionally or alternatively, a plurality of account identifiers may include a plurality of virtual account identifiers associated with a user (e.g., in addition to or in lieu of the lead account number). For example, the lead account identifier may include a debit account identifier (e.g., debit account number), and the plurality of virtual account identifiers may include a virtual credit account identifier (e.g., a virtual credit card number) and a virtual prepaid account identifier (e.g., a virtual prepaid card number).

As shown in FIG. 2, at step 204, process 200 may include determining a second account identifier. For example, system 100 (e.g., authorization system 102 and/or authorization rule database 104 thereof) may determine a second account identifier from a plurality of account identifiers based on at least one rule associated with the first account identifier. In some non-limiting embodiments or aspects, authorization system 102 and/or authorization rule database 104 may determine the second account identifier from the plurality of account identifiers based on at least one rule associated with the first account identifier. In some non-limiting embodiments or aspects, the at least one rule may be stored in authorization rule database 104. In some non-limiting embodiments or aspects, authorization rule database 104 may communicate the at least one rule (and/or rule data associated therewith) associated with the first account identifier to authorization system 102.

In some non-limiting embodiments or aspects, authorization system 102 may receive rule data associated with the at least one rule. For example, authorization system 102 may receive the rule data associated with the at least one rule from authorization rule database 104. The rule data associated with the at least one rule may include a threshold value. For example, authorization system 102 and/or authorization rule database 104 may determine whether a transaction amount of the payment transaction (e.g., associated with the authorization request) satisfies the threshold value. Authorization system 102 and/or authorization rule database 104 may identify (e.g., select) a second account identifier (e.g., from a plurality of account identifiers associated with the first account identifier and/or the user) in response to determining that the payment transaction satisfies the threshold. Additionally or alternatively, authorization system 102 and/or authorization rule database 104 may identify (e.g., select) a third account identifier (e.g., from the plurality of account identifiers) in response to determining that the payment transaction does not satisfy the threshold.

In some non-limiting embodiments or aspects, the rule data associated with the at least one rule may include at least one categorical criterion. For example, authorization system 102 and/or authorization rule database 104 may determine whether the payment transaction is in a selected category. For the purpose of illustration, if the selected category is cross-border transaction, authorization system 102 and/or authorization rule database 104 may determine whether the payment transaction is a cross-border transaction. Authorization system 102 and/or authorization rule database 104 may identify (e.g., select) a second account identifier (e.g., from a plurality of account identifiers associated with the first account identifier and/or the user) in response to determining that the payment transaction satisfies the categorical criterion (e.g., is a cross-border transaction). Additionally or alternatively, authorization system 102 and/or authorization rule database 104 may identify (e.g., select) a third account identifier (e.g., from the plurality of account identifiers) in response to determining that the payment transaction does not satisfy the categorical criterion (e.g., is not a cross-border transaction). As another illustration, if the selected category is an e-commerce transaction, authorization system 102 and/or authorization rule database 104 may determine whether the payment transaction is an e-commerce transaction. Authorization system 102 and/or authorization rule database 104 may identify (e.g., select) a second account identifier (e.g., from a plurality of account identifiers associated with the first account identifier and/or the user) in response to determining that the payment transaction satisfies the categorical criterion (e.g., is an e-commerce transaction). Additionally or alternatively, authorization system 102 and/or authorization rule database 104 may identify (e.g., select) a third account identifier (e.g., from the plurality of account identifiers) in response to determining that the payment transaction does not satisfy the categorical criterion (e.g., is not an e-commerce transaction). In some non-limiting embodiments or aspects, a categorical criterion may be combined with at least one other categorical criterion and/or at least one threshold value to create a complex rule (e.g., if the payment transaction is a cross-border transaction and an e-commerce transaction, select a second account identifier, otherwise select a third account identifier).

In some non-limiting embodiments or aspects, the at least one rule may include a first rule based on rule data received from the user and a fallback rule. Authorization system 102 may determine the second account identifier. For example authorization system 102 may determine that the first rule is not applicable to the payment transaction associated with the authorization request message. Authorization system 102 may determine (e.g., select) the second account identifier (e.g., from the plurality of account identifiers) based on the fallback rule in response to determining that the first rule is not applicable to the payment transaction.

In some non-limiting embodiments or aspects, the at least one rule and/or rule data associated therewith may be received by authorization rule database 104 from an issuer system. The at least one rule may be a rule that is configured by the user associated with the first account identifier or fallback rules configured by the issuer system and/or a transaction service provider system (e.g., authorization system 102 thereof).

In some non-limiting embodiments or aspects, the first account identifier may include a lead account identifier associated with a physical payment device associated with the user. Additionally or alternatively, a plurality of account identifiers may include a plurality of virtual account identifiers associated with a user (e.g., in addition to or in lieu of the lead account number). For example, the lead account identifier may include a debit account identifier (e.g., debit account number), and the plurality of virtual account identifiers may include a virtual credit account identifier (e.g., a virtual credit card number) and a virtual prepaid account identifier (e.g., a virtual prepaid card number). In some non-limiting embodiments or aspects, the second account identifier may include a selected virtual account identifier. For example, determining the second account identifier may include selecting the selected virtual account identifier from the plurality of virtual account identifiers based on the at least one rule.

As shown in FIG. 2, at step 206, process 200 may include generating a modified authorization request message. In some non-limiting embodiments or aspects, system 100 (e.g., authorization system 102 thereof) may generate a modified authorization request message for the payment transaction, and the modified authorization request message may include the second account identifier. For example, authorization system 102 may generate the modified authorization request message for the payment transaction with the second account identifier included (e.g., in lieu of the first account identifier). In some non-limiting embodiments or aspects, the modified authorization request may include other identifying information associated with the payment transaction (e.g., from the authorization request), such as a transaction identifier, a timestamp, a merchant identifier, a merchant account identifier, any combination thereof, and/or the like.

As shown in FIG. 2, at step 208, process 200 may include transmitting the modified authorization request message. For example, system 100 (e.g., authorization system 102 thereof) may transmit the modified authorization request message to an issuer system associated with the second account identifier. The issuer system may process the modified authorization request message (e.g., determine whether to authorize the payment transaction based on the modified authorization request message and/or the like) in response to receiving the modified authorization request message, as described herein.

As shown in FIG. 2, at step 210, process 200 may include storing a transaction history record. In some non-limiting embodiments or aspects, system 100 (e.g., authorization system 102 and/or transaction history database 106 thereof) may store the transaction history record. For example, authorization system 102 may store a transaction history record based on the payment transaction and the second account identifier in transaction history database 106. In some non-limiting embodiments or aspects, the transaction history record may include other identifying information associated with the payment transaction, such as the first account identifier, a transaction identifier, a retrieval reference number, a timestamp, a merchant identifier, a merchant account identifier, any combination thereof, and/or the like.

In some non-limiting embodiments or aspects, the issuer system may determine whether to authorize the payment transaction based on the modified authorization request message. For example, the issuer system may generate an authorization decision (e.g., authorize, decline, and/or the like) based on the modified authorization request message. For the purpose of illustration, if the account associated with the second account identifier has sufficient funds and/or available credit for the payment transaction (e.g., based on the transaction amount in the modified authorization request), the issuer system may determine to authorize the transaction. Additionally or alternatively, if the account associated with the second account identifier does not have sufficient funds and/or available credit for the payment transaction (e.g., based on the transaction amount in the modified authorization request) and/or if some other criteria for not authorizing the payment transaction are satisfied (e.g., fraud detection criteria, anti-money laundering criteria, cross-border transaction prohibition, and/or the like), the issuer system may determine to not authorize (e.g., decline, reject, and/or the like) the transaction. In some non-limiting embodiments or aspects, the issuer system may generate an authorization response based on determining whether to authorize the payment transaction (e.g., based on the authorization decision). For example, the authorization response may include the second account identifier.

In some non-limiting embodiments or aspects, system 100 (e.g., authorization system 102 thereof) may receive the authorization response, e.g., from the issuer system. In some non-limiting embodiments or aspects, system 100 (e.g., authorization system 102 thereof) may generate a modified authorization response. For example, authorization system 102 may generate a modified authorization response for the payment transaction, and the modified authorization response may include the first account identifier. For example, authorization system 102 may identify the transaction history record associated with the payment transaction (e.g., the transaction history record may indicate that the second account identifier was substituted for the first account identifier when generating the modified authorization request), and/or authorization system 102 may generate the modified authorization response for the payment transaction with the first account identifier included (e.g., in lieu of the second account identifier) based on identifying the transaction history record. In some non-limiting embodiments or aspects, authorization system 102 may communicate the modified authorization response, e.g., to an acquirer system and/or a payment gateway system (e.g., that initially communicated the authorization request).

As shown in FIG. 2, at step 212, process 200 may include receiving the settlement request message. In some non-limiting embodiments or aspects, system 100 (e.g., settlement system 108 thereof) may receive the settlement request message. For example, settlement system 108 may receive the settlement request message associated with the payment transaction (e.g., from an acquirer system and/or payment gateway system), and the settlement request message may include the first account identifier. The settlement request message may be received from an acquirer system and/or a payment gateway system. In some non-limiting embodiments or aspects, the settlement request message may include other identifying information associated with the payment transaction, such as a transaction identifier, a retrieval reference number, a timestamp, a merchant identifier, a merchant account identifier, any combination thereof, and/or the like.

As shown in FIG. 2, at step 214, process 200 may include identifying the transaction history record. In some non-limiting embodiments or aspects, system 100 (e.g., settlement system 108 and/or transaction history database 106 thereof) may identify the transaction history record. For example, settlement system 108 may identify the transaction history record stored in transaction history database 106 based on the payment transaction and/or the settlement request message associated therewith. Additionally or alternatively, settlement system 108 may identify the transaction history record stored in transaction history database 106 based on other identifying information from the settlement request message matching corresponding identifying information in the transaction history record. As such, the transaction history record regarding payment transaction associated with the first account identifier may be identified. Additionally, the second account identifier associated with the payment transaction may be determined based on the transaction history record, e.g., since the transaction history record was generated based on (e.g., included) the second account identifier.

In some non-limiting embodiments or aspects, settlement system 108 may not identify a transaction history record (e.g., because there is no transaction history record associated with the payment transaction stored in transaction history database 106). Additionally or alternatively, settlement system 108 may identify a fallback rule associated with the first account identifier.

As shown in FIG. 2, at step 216, process 200 may include generating a modified settlement request message. In some non-limiting embodiments or aspects, system 100 (e.g., settlement system 108 thereof) may generate the modified settlement request message. For example, settlement system 108 may generate a modified settlement request message based on identifying the transaction history record, and the modified settlement request message may include the second account identifier (e.g., in lieu of the first account identifier). Additionally or alternatively, if there is not a transaction history record, settlement system 108 may generate a modified settlement request message based on a fallback settlement rule, as described herein.

In some non-limiting embodiments or aspects, the modified settlement request message may include other identifying information associated with the payment transaction (e.g., from the settlement request message), such as a transaction identifier, a retrieval reference number, a timestamp, a merchant identifier, a merchant account identifier, any combination thereof, and/or the like.

As shown in FIG. 2, at step 218, process 200 may include transmitting the modified settlement request message. In some non-limiting embodiments or aspects, system 100 (e.g., settlement system 108 thereof) may transmit the modified settlement request message. For example, settlement system 108 may transmit the modified settlement request message to the issuer system associated with the second account identifier.

In some non-limiting embodiments or aspects, the issuer system may generate a settlement response (e.g., a clearing message and/or the like) based on the modified settlement request message. For example, the settlement response may include the second account identifier. In some non-limiting embodiments or aspects, the settlement response message may include other identifying information associated with the payment transaction (e.g., from the settlement request message), such as a transaction identifier, a retrieval reference number, a timestamp, a merchant identifier, a merchant account identifier, any combination thereof, and/or the like.

In some non-limiting embodiments or aspects, system 100 (e.g., settlement system 108 thereof) may receive the settlement response, e.g., from the issuer system. In some non-limiting embodiments or aspects, system 100 (e.g., settlement system 108 thereof) may generate a modified settlement response. For example, settlement system 108 may generate a modified settlement response for the payment transaction, and the modified settlement response may include the first account identifier. For example, settlement system 108 may identify the transaction history record associated with the payment transaction (e.g., the transaction history record may indicate that the second account identifier was substituted for the first account identifier when generating the modified authorization request), and/or settlement system 108 may generate the modified settlement response for the payment transaction with the first account identifier included (e.g., in lieu of the second account identifier) based on identifying the transaction history record. In some non-limiting embodiments or aspects, settlement system 108 may communicate the modified settlement response, e.g., to an acquirer system and/or a payment gateway system (e.g., that initially communicated the settlement request).

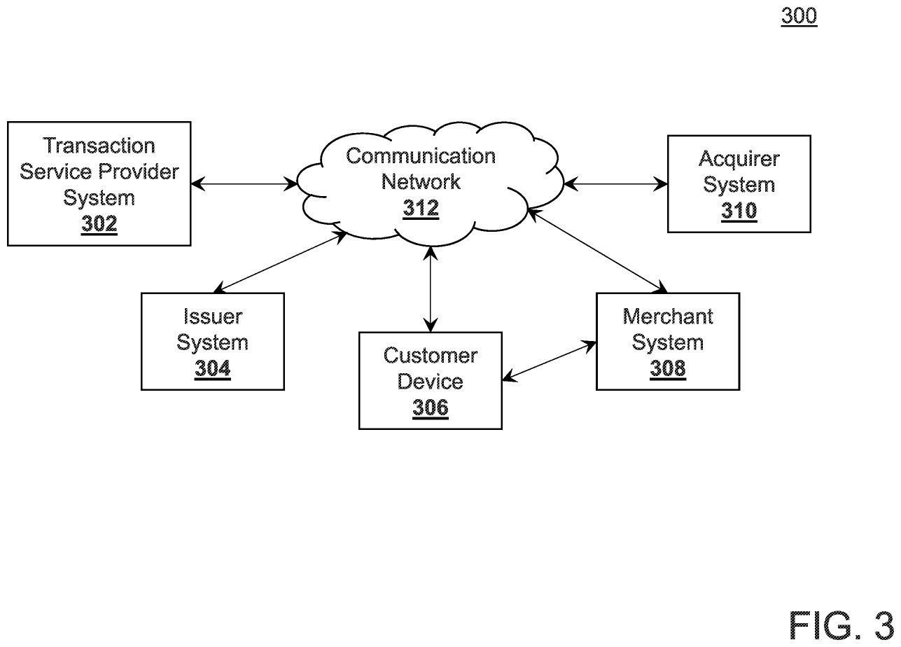

Referring now to FIG. 3, FIG. 3 is a diagram of a non-limiting embodiment or aspect of an exemplary environment 300 in which systems, products, and/or methods, as described herein, may be implemented. As shown in FIG. 3, environment 300 may include transaction service provider system 302, issuer system 304, customer device 306, merchant system 308, acquirer system 310, and communication network 312. In some non-limiting embodiments or aspects, system 100, authorization system 102, authorization rule database 104, transaction history database 106, settlement system 108, and/or settlement rule database 110 may be implemented by (e.g., part of) transaction service provider system 302. In some non-limiting embodiments or aspects, at least one of system 100, authorization system 102, authorization rule database 104, transaction history database 106, settlement system 108, and/or settlement rule database 110 may be implemented by (e.g., part of) another system, another device, another group of systems, or another group of devices, separate from or including transaction service provider system 302, such as issuer system 304, merchant system 308, acquirer system 310, and/or the like.

Transaction service provider system 302 may include one or more devices capable of receiving information from and/or communicating information to issuer system 304, customer device 306, merchant system 308, and/or acquirer system 310 via communication network 312. For example, transaction service provider system 302 may include a computing device, such as a server (e.g., a transaction processing server), a group of servers, and/or other like devices. In some non-limiting embodiments or aspects, transaction service provider system 302 may be associated with a transaction service provider as described herein. In some non-limiting embodiments or aspects, transaction service provider system 302 may be in communication with a data storage device, which may be local or remote to transaction service provider system 302. In some non-limiting embodiments or aspects, transaction service provider system 302 may be capable of receiving information from, storing information in, communicating information to, or searching information stored in the data storage device.

Issuer system 304 may include one or more devices capable of receiving information and/or communicating information to transaction service provider system 302, customer device 306, merchant system 308, and/or acquirer system 310 via communication network 312. For example, issuer system 304 may include a computing device, such as a server, a group of servers, and/or other like devices. In some non-limiting embodiments or aspects, issuer system 304 may be associated with an issuer institution as described herein. For example, issuer system 304 may be associated with an issuer institution that issued a credit account, debit account, credit card, debit card, and/or the like to a user associated with customer device 306.

Customer device 306 may include one or more devices capable of receiving information from and/or communicating information to transaction service provider system 302, issuer system 304, merchant system 308, and/or acquirer system 310 via communication network 312. Additionally or alternatively, each customer device 306 may include a device capable of receiving information from and/or communicating information to other customer devices 306 via communication network 312, another network (e.g., an ad hoc network, a local network, a private network, a virtual private network, and/or the like), and/or any other suitable communication technique. For example, customer device 306 may include a client device and/or the like. In some non-limiting embodiments or aspects, customer device 306 may or may not be capable of receiving information (e.g., from merchant system 308 or from another customer device 306) via a short-range wireless communication connection (e.g., an NFC communication connection, an RFID communication connection, a Bluetooth® communication connection, a Zigbee® communication connection, and/or the like), and/or communicating information (e.g., to merchant system 308) via a short-range wireless communication connection.

Merchant system 308 may include one or more devices capable of receiving information from and/or communicating information to transaction service provider system 302, issuer system 304, customer device 306, and/or acquirer system 310 via communication network 312. Merchant system 308 may also include a device capable of receiving information from customer device 306 via communication network 312, a communication connection (e.g., an NFC communication connection, an RFID communication connection, a Bluetooth® communication connection, a Zigbee® communication connection, and/or the like) with customer device 306, and/or the like, and/or communicating information to customer device 306 via communication network 312, the communication connection, and/or the like. In some non-limiting embodiments or aspects, merchant system 308 may include a computing device, such as a server, a group of servers, a client device, a group of client devices, and/or other like devices. In some non-limiting embodiments or aspects, merchant system 308 may be associated with a merchant as described herein. In some non-limiting embodiments or aspects, merchant system 308 may include one or more client devices. For example, merchant system 308 may include a client device that allows a merchant to communicate information to transaction service provider system 302. In some non-limiting embodiments or aspects, merchant system 308 may include one or more devices, such as computers, computer systems, and/or peripheral devices capable of being used by a merchant to conduct a transaction with a user. For example, merchant system 308 may include a POS device and/or a POS system.

Acquirer system 310 may include one or more devices capable of receiving information from and/or communicating information to transaction service provider system 302, issuer system 304, customer device 306, and/or merchant system 308 via communication network 312. For example, acquirer system 310 may include a computing device, a server, a group of servers, and/or the like. In some non-limiting embodiments or aspects, acquirer system 310 may be associated with an acquirer as described herein.

Communication network 312 may include one or more wired and/or wireless networks. For example, communication network 312 may include a cellular network (e.g., a long-term evolution (LTE) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

The number and arrangement of systems, devices, and/or networks shown in FIG. 3 are provided as an example. There may be additional systems, devices, and/or networks; fewer systems, devices, and/or networks; different systems, devices, and/or networks; and/or differently arranged systems, devices, and/or networks than those shown in FIG. 3. Furthermore, two or more systems or devices shown in FIG. 3 may be implemented within a single system or device, or a single system or device shown in FIG. 3 may be implemented as multiple, distributed systems or devices. Additionally or alternatively, a set of systems (e.g., one or more systems) or a set of devices (e.g., one or more devices) of environment 300 may perform one or more functions described as being performed by another set of systems or another set of devices of environment 300.

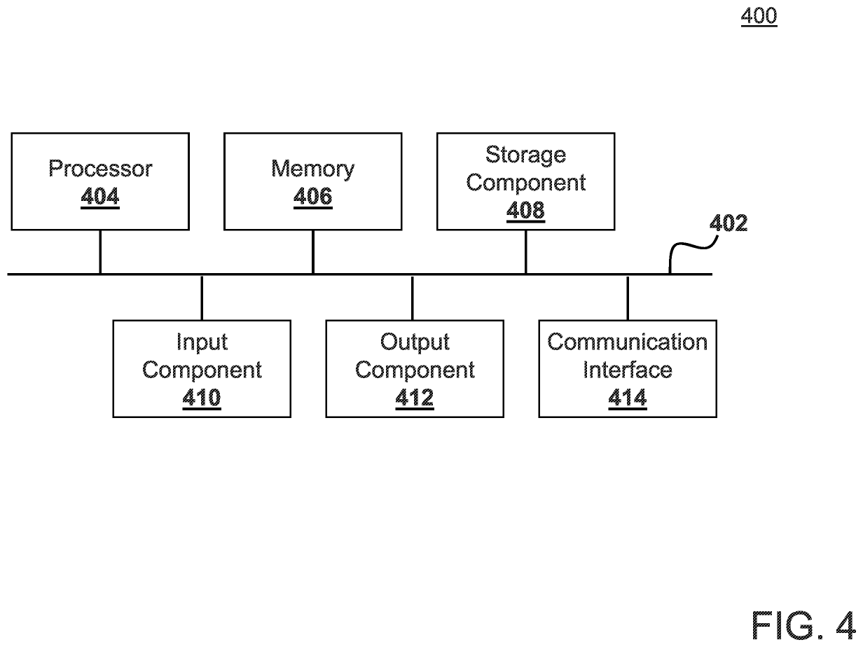

Referring now to FIG. 4, shown is a diagram of example components of a device 400 according to non-limiting embodiments or aspects. Device 400 may correspond to at least one of system 100, authorization system 102, authorization rule database 104, transaction history database 106, settlement system 108, and/or settlement rule database 110 in FIG. 1 and/or at least one of transaction service provider system 302, issuer system 304, customer device 306, merchant system 308, and/or acquirer system 310 in FIG. 3, as an example. In some non-limiting embodiments or aspects, such systems or devices in FIG. 1 or FIG. 3 may include at least one device 400 and/or at least one component of device 400. The number and arrangement of components shown in FIG. 4 are provided as an example. In some non-limiting embodiments or aspects, device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

As shown in FIG. 4, device 400 may include a bus 402, a processor 404, memory 406, a storage component 408, an input component 410, an output component 412, and a communication interface 414. Bus 402 may include a component that permits communication among the components of device 400. In some non-limiting embodiments or aspects, processor 404 may be implemented in hardware, firmware, or a combination of hardware and software. For example, processor 404 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 406 may include random access memory (RAM), read only memory (ROM), and/or another type of dynamic or static storage device (e.g., flash memory, magnetic memory, optical memory, etc.) that stores information and/or instructions for use by processor 404.

With continued reference to FIG. 4, storage component 408 may store information and/or software related to the operation and use of device 400. For example, storage component 408 may include a hard disk (e.g., a magnetic disk, an optical disk, a magneto-optic disk, a solid state disk, etc.) and/or another type of computer-readable medium. Input component 410 may include a component that permits device 400 to receive information, such as via user input (e.g., a touch screen display, a keyboard, a keypad, a mouse, a button, a switch, a microphone, etc.). Additionally, or alternatively, input component 410 may include a sensor for sensing information (e.g., a global positioning system (GPS) component, an accelerometer, a gyroscope, an actuator, etc.). Output component 412 may include a component that provides output information from device 400 (e.g., a display, a speaker, one or more light-emitting diodes (LEDs), etc.). Communication interface 414 may include a transceiver-like component (e.g., a transceiver, a separate receiver and transmitter, etc.) that enables device 400 to communicate with other devices, such as via a wired connection, a wireless connection, or a combination of wired and wireless connections. Communication interface 414 may permit device 400 to receive information from another device and/or provide information to another device. For example, communication interface 414 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 400 may perform one or more processes described herein. Device 400 may perform these processes based on processor 404 executing software instructions stored by a computer-readable medium, such as memory 406 and/or storage component 408. A computer-readable medium may include any non-transitory memory device. A memory device includes memory space located inside of a single physical storage device or memory space spread across multiple physical storage devices. Software instructions may be read into memory 406 and/or storage component 408 from another computer-readable medium or from another device via communication interface 414. When executed, software instructions stored in memory 406 and/or storage component 408 may cause processor 404 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

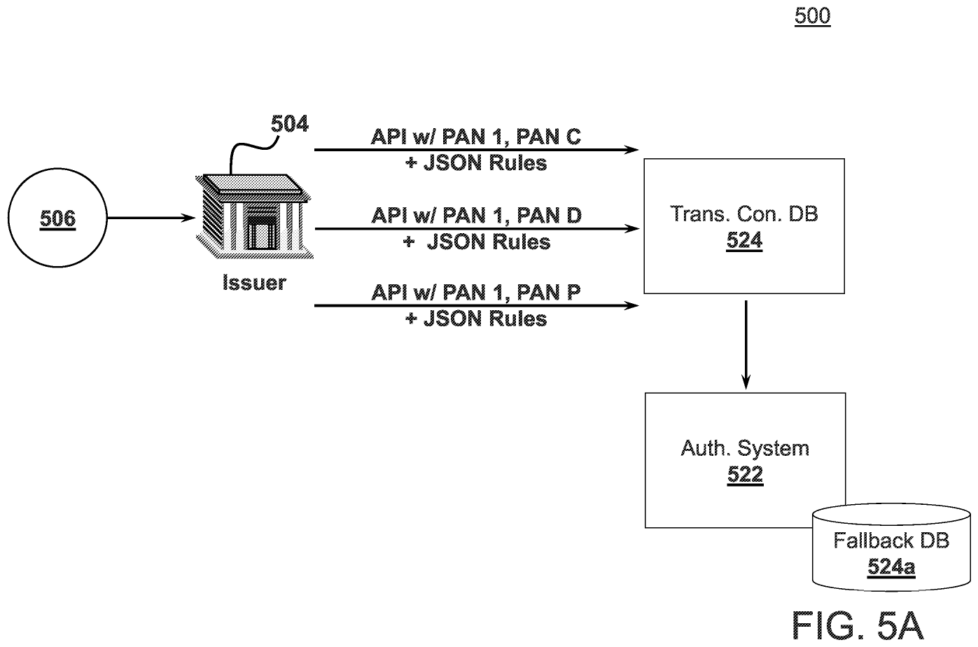

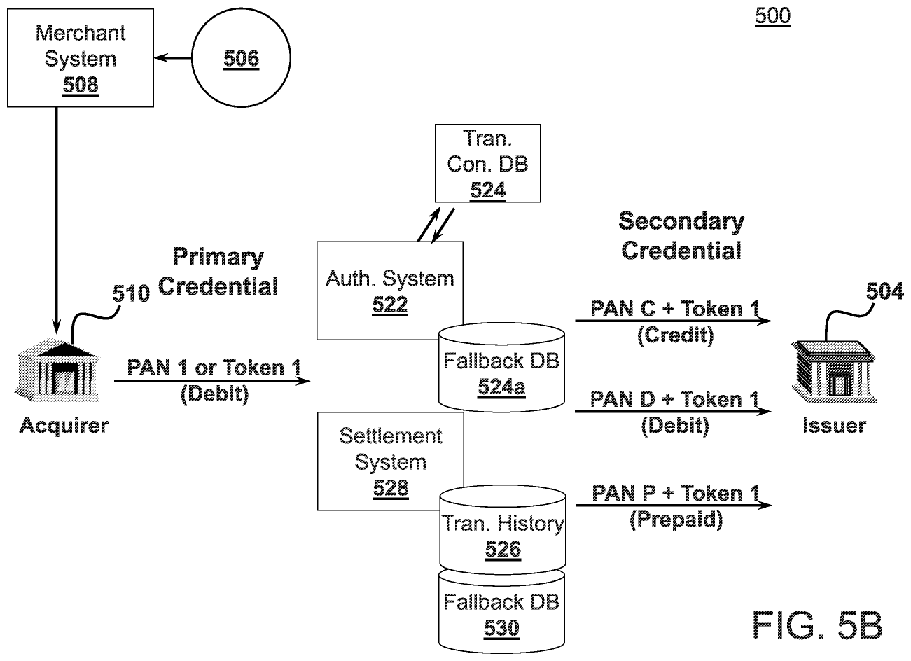

Referring now to FIGS. 5A and 5B, shown are schematic diagrams of an implementation 500 of systems and methods for flexible transaction message routing according to some non-limiting embodiments or aspects. As shown in FIGS. 5A and 5B, implementation 500 may include issuer system 504, user 506, merchant system 508, acquirer system 510, authorization system 522, transaction control database 524, authorization fallback rules database 524a, transaction history database 526, settlement system 528, and/or settlement fallback rules database 530. In some non-limiting embodiments or aspects, issuer system 504 may be the same as or similar to issuer system 304. In some non-limiting embodiments or aspects, user 506 may be the same as or similar to customer device 306. In some non-limiting embodiments or aspects, merchant system 508 may be the same as or similar to merchant system 308. In some non-limiting embodiments or aspects, acquirer system 510 may be the same as or similar to acquirer system 310. In some non-limiting embodiments or aspects, authorization system 522 may be the same as, similar to, or part of authorization system 102 and/or transaction service provider system 302. In some non-limiting embodiments or aspects, transaction control database 524 may be the same as or similar to authorization rule database 104 and/or transaction service provider system 302. In some non-limiting embodiments or aspects, authorization fallback rules database 524a may be the same as, similar to, or part of authorization rule database 104 and/or transaction service provider system 302. In some non-limiting embodiments or aspects, transaction history database 526 may be the same as, similar to, or part of transaction history database 106 and/or transaction service provider system 302. In some non-limiting embodiments or aspects, settlement system 528 may be the same as, similar to, or part of settlement system 108 and/or transaction service provider system 302. In some non-limiting embodiments or aspects, settlement fallback rules database 530 may be the same as, similar to, or part of settlement rule database 110 and/or transaction service provider system 302.

With reference to FIG. 5A, in some non-limiting embodiments or aspects, user 506 may communicate and/or set (e.g., configure, input, and/or the like) rule data associated with at least one rule. For example, user 506 may communicate rule data to issuer system 504 and/or transaction control database 524 (e.g., using a computing device, such as customer device 306 and/or the like). For example, user 506 may use an application (e.g., mobile application) associated with issuer system 504 and/or transaction control database 524 on a computing device (e.g., customer device 306 and/or the like) to input rule data associated with at least one rule.

In some non-limiting embodiments or aspects, issuer system 504 may receive rule data (e.g., from user 506). Additionally or alternatively, issuer system 504 may communicate rule data to transaction control database 524, which may receive the rule data, as described herein. For example, issuer system 504 may use an application programming interface (API) to communicate the rule data to transaction control database 524. The API may be provided by transaction control database 524 and/or by a transaction service provider system (e.g., transaction service provider system 302 and/or the like). In some non-limiting embodiments or aspects, the rule data may include a first account identifier (e.g., a lead account identifier (PAN 1), and/or the like) and/or at least one second account identifier (e.g., a credit account identifier (PAN C), a debit account identifier (PAN D), a prepaid account identifier (PAN P), at least one virtual account identifier, a virtual credit account identifier, a virtual prepaid account identifier, a virtual debit account identifier, any combination thereof, and/or the like). Additionally or alternatively, the rule data may include data representing at least one rule in a specified format (e.g., a standardized format, JavaScript Object Notation (JSON) format, and/or the like). In some non-limiting embodiments or aspects, transaction control database 524 may store the rule data and/or communicate the rule data to authorization system 522.

In some non-limiting embodiments or aspects, issuer system 504 and/or transaction control database 524 may receive at least one modification to the rule data (e.g., from user 506). For example, a modification to the rule data may include at least one of adding a new secondary account identifier, removing a secondary account identifier, changing which account identifier is the lead account identifier, replacing the lead account identifier with a new account identifier, and/or the like. Additionally or alternatively, a modification to the rule data may include at least one of adding a new rule, removing an existing rule, modifying an existing rule, and/or the like.

In some non-limiting embodiments or aspects, the rule data may include at least one fallback rule, as described herein. In some non-limiting embodiments or aspects, transaction control database 524 may store the fallback rule(s). Additionally or alternatively, authorization fallback rules database 524a may store the fallback rule(s).

With reference to FIG. 5B, in some non-limiting embodiments or aspects, user 506 may initiate a payment transaction with merchant system 508. For example, user 506 may use a physical payment device associated with a first account identifier (e.g., lead PAN (PAN 1)) to initiate a payment transaction with a POS device of merchant system 508. Additionally or alternatively, user 506 may use a computing device (e.g., customer device 306 and/or the like) to initiate a payment transaction with merchant system 508 using the first account identifier (e.g., lead PAN (PAN 1) or a token (Token 1)).

In some non-limiting embodiments or aspects, merchant system 508 may generate an authorization request message associated with the payment transaction. For example, the authorization request message may include the first account identifier (e.g., lead PAN (PAN 1)). Merchant system 508 may communicate the authorization request to acquirer system 510 (and/or a payment gateway), which may communicate the authorization request to authorization system 522.

In some non-limiting embodiments or aspects, authorization system 522 may receive the authorization request. Additionally or alternatively, authorization system 522 may determine a second account identifier (e.g., one of the credit account identifier (PAN C), the debit account identifier (PAN D), the prepaid account identifier (PAN P), or the like) from a plurality of account identifiers based on at least one rule associated with the first account identifier (e.g., lead PAN (PAN 1)). For example, authorization system 522 may receive (e.g., retrieve, access, read, and/or the like) the rule data from transaction control database 524. Additionally or alternatively, authorization system 522 may determine a second account identifier based on the rule data.

In some non-limiting embodiments or aspects, the rule data may include at least one threshold value (e.g., at least one threshold transaction amount value). Authorization system 522 may determine whether a transaction amount of the payment transaction (e.g., which may be part of the authorization request) satisfies the threshold value. For example, determining the second account identifier may include selecting the second account identifier from the plurality of account identifiers based on the transaction amount satisfying the threshold value(s).

In some non-limiting embodiments or aspects, the at least one rule may include a first rule based on rule data received from user 506 and/or stored by transaction control database 524. Additionally or alternatively, at least one fallback rule may be stored (e.g., by transaction control database 524 and/or authorization fallback rule database 524a). Determining the second account identifier may include authorization system 522 determining the first rule is not applicable to the payment transaction associated with the authorization request message. In response to determining that the first rule is not applicable, authorization system 522 may determine the second account identifier from the plurality of account identifiers based on the fallback rule.

In some non-limiting embodiments or aspects, authorization system 522 may generate a modified authorization request message for the payment transaction. For example, the modified authorization request message may include the second account identifier (e.g., one of the credit account identifier (PAN C), the debit account identifier (PAN D), the prepaid account identifier (PAN P), or the like). In some non-limiting embodiments or aspects, the modified authorization request message may include a token (e.g., Token 1) associated with the user (e.g., the token may indicate that flexible transaction message routing is being utilized). In some non-limiting embodiments or aspects, authorization system 522 may transmit the modified authorization request message to issuer system 504, which may be associated with the second account identifier. In some non-limiting embodiments or aspects, authorization system 522 may store a transaction history record based on the payment transaction and/or the second account identifier in the transaction history database 526.

In some non-limiting embodiments or aspects, issuer system 504 may determine whether to authorize the payment transaction based on the modified authorization request message, as described herein. For example, issuer system 504 may generate an authorization decision (e.g., authorize, decline, and/or the like) based on the modified authorization request message, as described herein. In some non-limiting embodiments or aspects, issuer system 504 may generate an authorization response based on determining whether to authorize the payment transaction (e.g., based on the authorization decision), as described herein. For example, the authorization response may include the second account identifier.

In some non-limiting embodiments or aspects, authorization system 522 may receive the authorization response, e.g., from issuer system 504. In some non-limiting embodiments or aspects, authorization system 522 thereof may generate a modified authorization response, as described herein. For example, authorization system 522 may identify the transaction history record stored in transaction history database 526 associated with the payment transaction (e.g., the transaction history record may indicate that the second account identifier was substituted for the first account identifier when generating the modified authorization request), and/or authorization system 522 may generate the modified authorization response for the payment transaction with the first account identifier included (e.g., in lieu of the second account identifier) based on identifying the transaction history record. In some non-limiting embodiments or aspects, authorization system 522 may communicate the modified authorization response, e.g., to an acquirer system and/or a payment gateway system (e.g., that initially communicated the authorization request).

In some non-limiting embodiments or aspects, acquirer system 510 may generate a settlement request message associated with the payment transaction. For example, the settlement request may be generated after a time period (e.g., predetermined time period, minimum time period, selected time period, and/or the like) after the authorization request message was initially communicated. In some non-limiting embodiments or aspects, the settlement request message may include the first account identifier (e.g., lead pan (PAN 1) and/or the token (Token 1)). Additionally or alternatively, the settlement request may include other identifying information associated with the payment transaction, such as a transaction identifier, a timestamp, a merchant identifier, a merchant account identifier, any combination thereof, and/or the like. In some non-limiting embodiments or aspects, acquirer system 510 may communicate the settlement request message to settlement system 528.

In some non-limiting embodiments or aspects, settlement system 528 may receive the settlement request message associated with the payment transaction (e.g., from acquirer system 510). In some non-limiting embodiments or aspects, settlement system 528 and/or transaction history database 526 may identify the transaction history record based on the payment transaction. For example, settlement system 528 may receive (e.g., retrieve, request and receive, and/or the like) the transaction history record from transaction history database 526, and/or settlement system 528 may receive the second account identifier associated with the transaction history record from transaction history record from transaction history database 526.

In some non-limiting embodiments or aspects, settlement system 528 may generate a modified settlement request message. For example, settlement system 528 may generate a modified settlement request message based on identifying the transaction history record and/or receiving the second account identifier. In some non-limiting embodiments or aspects, the modified settlement request message may include the second account identifier. Additionally or alternatively, the modified settlement request may include other identifying information associated with the payment transaction, such as a transaction identifier, a timestamp, a merchant identifier, a merchant account identifier, any combination thereof, and/or the like.

In some non-limiting embodiments or aspects, settlement system 528 may communicate the modified settlement request message to issuer system 504 associated with the second account identifier.

In some non-limiting embodiments or aspects, settlement system 528 may determine there is no transaction history record associated with the payment transaction stored in the transaction history database 526. In response to such a determination, settlement system 528 may apply a fallback settlement rule. For example, settlement system 528 may receive (e.g., retrieve, request and receive, and/or the like) the fallback settlement rule from settlement fallback rules database 530.

In some non-limiting embodiments or aspects, issuer system 504 may generate a settlement response (e.g., a clearing message and/or the like) based on the modified settlement request message. For example, the settlement response may include the second account identifier.

In some non-limiting embodiments or aspects, settlement system 528 may receive the settlement response, e.g., from issuer system 504. In some non-limiting embodiments or aspects, settlement system 528 may generate a modified settlement response, as described herein. For example, settlement system 528 may generate a modified settlement response for the payment transaction, and the modified settlement response may include the first account identifier. For example, settlement system 528 may identify the transaction history record stored in transaction history database 526 associated with the payment transaction (e.g., the transaction history record may indicate that the second account identifier was substituted for the first account identifier when generating the modified authorization request), and/or settlement system 528 may generate the modified settlement response for the payment transaction with the first account identifier included (e.g., in lieu of the second account identifier) based on identifying the transaction history record, as described herein. In some non-limiting embodiments or aspects, settlement system 528 may communicate the modified settlement response, e.g., to acquirer system 510 and/or a payment gateway system (e.g., that initially communicated the settlement request).

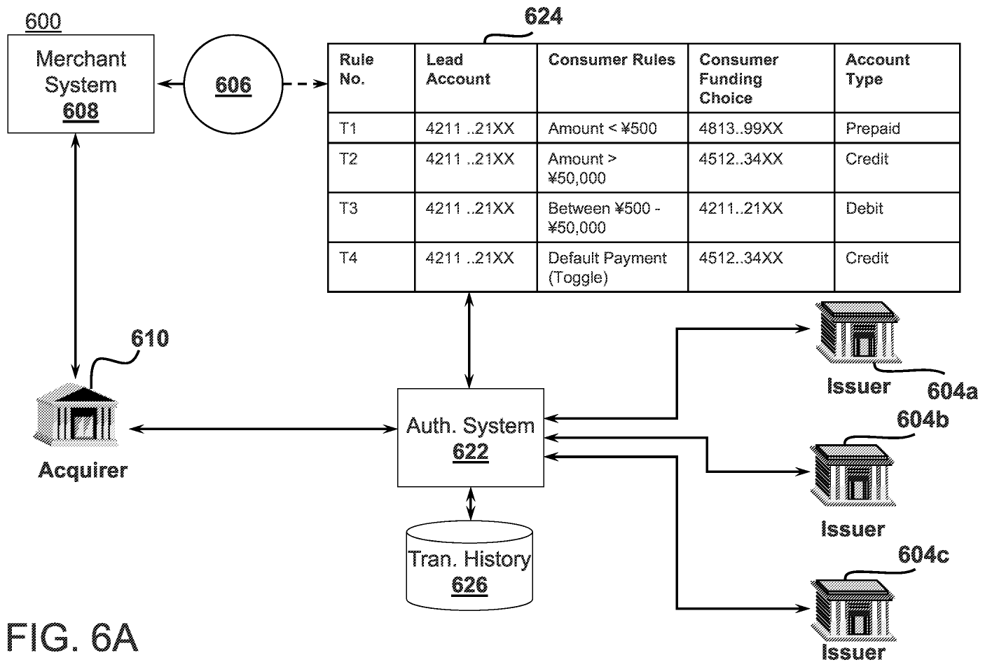

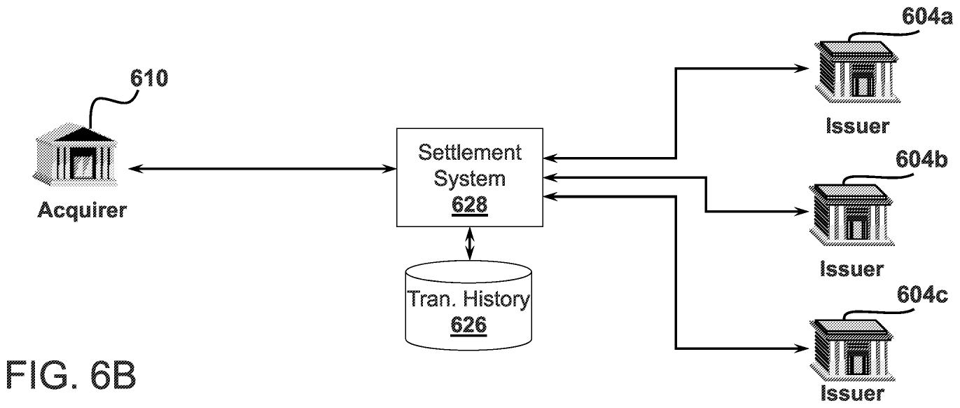

Referring now to FIGS. 6A and 6B, shown are schematic diagrams of an implementation 600 of systems and methods for flexible transaction message routing according to some non-limiting embodiments or aspects. As shown in FIGS. 6A and 6B, implementation 600 may include at least one issuer system 604a, 604b, 604c, user 606, merchant system 608, acquirer system 610, authorization system 622, transaction control database 624, transaction history database 626, and/or settlement system 628. In some non-limiting embodiments or aspects, issuer system(s) 604a, 604b, 604c may be the same as or similar to issuer system 304. In some non-limiting embodiments or aspects, user 606 may be the same as or similar to customer device 306. In some non-limiting embodiments or aspects, merchant system 608 may be the same as or similar to merchant system 308. In some non-limiting embodiments or aspects, acquirer system 610 may be the same as or similar to acquirer system 310. In some non-limiting embodiments or aspects, authorization system 622 may be the same as, similar to, or part of authorization system 102 and/or transaction service provider system 302. In some non-limiting embodiments or aspects, transaction control database 624 may be the same as or similar to authorization rule database 104 and/or transaction service provider system 302. In some non-limiting embodiments or aspects, transaction history database 626 may be the same as, similar to, or part of transaction history database 106 and/or transaction service provider system 302. In some non-limiting embodiments or aspects, settlement system 628 may be the same as, similar to, or part of settlement system 108 and/or transaction service provider system 302. In some non-limiting embodiments or aspects, first issuer system 604a, second issuer system 604b, and third issuer system 604c may be part of the same system (e.g., a debit system, a credit system, and a prepaid system of the same issuer system) and/or associated with the same issuer. In some non-limiting embodiments or aspects, first issuer system 604a, second issuer system 604b, and third issuer system 604c may be separate issuer systems, each be associated with a separate issuer.

With reference to FIG. 6A, in some non-limiting embodiments or aspects, user 606 may communicate and/or set (e.g., configure, input, and/or the like) rule data associated with at least one rule. For example, user 606 may communicate rule data to an issuer system (e.g., at least one of issuer systems 604a, 604b, 604c) and/or transaction control database 624 (e.g., using a computing device, such as customer device 306 and/or the like). For example, user 606 may use an application (e.g., mobile application) associated with the issuer system and/or transaction control database 624 on a computing device (e.g., customer device 306 and/or the like) to input rule data associated with at least one rule.

In some non-limiting embodiments or aspects, the issuer system (e.g., at least one of issuer systems 604a, 604b, 604c) and/or transaction control database 624 may receive at least one modification to the rule data (e.g., from user 606). For example, a modification to the rule data may include at least one of adding a new secondary account identifier, removing a secondary account identifier, changing which account identifier is the lead account identifier, replacing the lead account identifier with a new account identifier, and/or the like. Additionally or alternatively, a modification to the rule data may include at least one of adding a new rule, removing an existing rule, modifying an existing rule, and/or the like.

In some non-limiting embodiments or aspects, transaction control database 624 may receive the rule data, as described herein. In some non-limiting embodiments or aspects, the rule data may include a first account identifier (e.g., Lead Account) and/or at least one second account identifier (e.g., a Consumer Funding Choice for each rule, such as a (virtual) credit account identifier, a (virtual) prepaid account identifier, a (virtual) debit account identifier, any combination thereof, and/or the like). Additionally or alternatively, the rule data may include data representing each rule in a specified format (e.g., Consumer Rules). Additionally or alternatively, the rule data may include a rule identification number for each rule (e.g., Rule No.), an account type associated with each rule (e.g., Prepaid, Credit, Debit, and/or the like), any combination thereof, and/or the like. In some non-limiting embodiments or aspects, the rule data may include at least one fallback rule (e.g., Default Payment), as described herein. In some non-limiting embodiments or aspects, transaction control database 624 may store the rule data and/or communicate the rule data to authorization system 622.

In some non-limiting embodiments or aspects, user 606 may initiate a payment transaction with merchant system 608. For example, user 606 may use a physical payment device associated with a first account identifier (e.g., Lead Account) to initiate a payment transaction with a POS device of merchant system 608. Additionally or alternatively, user 606 may use a computing device (e.g., customer device 306 and/or the like) to initiate a payment transaction with merchant system 608 using the first account identifier (e.g., Lead Account).

In some non-limiting embodiments or aspects, merchant system 608 may generate an authorization request message associated with the payment transaction. For example, the authorization request message may include the first account identifier (e.g., Lead Account). Merchant system 608 may communicate the authorization request to acquirer system 610 (and/or a payment gateway), which may communicate the authorization request to authorization system 622.

In some non-limiting embodiments or aspects, authorization system 622 may receive the authorization request. Additionally or alternatively, authorization system 622 may determine a second account identifier (e.g., one of the Consumer Funding Choices) from a plurality of account identifiers based on at least one rule stored in transaction control database 624. For example, authorization system 622 may receive (e.g., retrieve, access, read, and/or the like) the rule data from transaction control database 624. Additionally or alternatively, authorization system 622 may determine a second account identifier based on the rule data.

In some non-limiting embodiments or aspects, the rule data may include at least one threshold value (e.g., at least one threshold transaction amount value). For example, as shown in FIG. 6A, a first rule (T1) may be associated with a transaction amount being less than a first threshold value of 500 Yen (e.g., Amount<¥500), a second rule (T2) may be associated with a transaction amount being greater than a second threshold value of 50,000 Yen (e.g., Amount>¥50,000), and a third rule (T4) may be associate with a transaction amount being between the first and second threshold values (e.g., Between ¥500-¥50,000). Authorization system 622 may determine whether a transaction amount of the payment transaction (e.g., which may be part of the authorization request) satisfies one of these threshold values. For example, determining the second account identifier may include selecting the second account identifier from the plurality of account identifiers (e.g., the Consumer Funding Choice associated with each rule) based on the transaction amount satisfying the threshold value(s) of one of the rules.

In some non-limiting embodiments or aspects, the at least one rule may include a first rule based on rule data received from user 606 and/or stored by transaction control database 624. Additionally or alternatively, at least one fallback rule (e.g., Default Payment) may be stored (e.g., by transaction control database 624). Determining the second account identifier may include authorization system 622 determining the first three rules (T1-T3) are not applicable to the payment transaction associated with the authorization request message. In response to determining that the rules are not applicable, authorization system 622 may determine the second account identifier based on the fallback rule (e.g., Default Payment).

In some non-limiting embodiments or aspects, authorization system 622 may generate a modified authorization request message for the payment transaction. For example, the modified authorization request message may include the second account identifier (e.g., one of the Consumer Funding Choices). In some non-limiting embodiments or aspects, authorization system 622 may transmit the modified authorization request message to an issuer system associated with the second account identifier (e.g., one of the first issuer system 604a, the second issuer system 604b, and/or the third issuer system 604c based on which one of these issuer systems issued the second account identifier). In some non-limiting embodiments or aspects, authorization system 622 may store a transaction history record based on the payment transaction and/or the second account identifier in the transaction history database 626.

In some non-limiting embodiments or aspects, issuer system 604 may determine whether to authorize the payment transaction based on the modified authorization request message, as described herein. For example, issuer system 604 may generate an authorization decision (e.g., authorize, decline, and/or the like) based on the modified authorization request message, as described herein. In some non-limiting embodiments or aspects, issuer system 604 may generate an authorization response based on determining whether to authorize the payment transaction (e.g., based on the authorization decision), as described herein. For example, the authorization response may include the second account identifier.

In some non-limiting embodiments or aspects, authorization system 602 may receive the authorization response, e.g., from issuer system 604. In some non-limiting embodiments or aspects, authorization system 602 thereof may generate a modified authorization response, as described herein. For example, authorization system 602 may identify the transaction history record stored in transaction history database 626 associated with the payment transaction (e.g., the transaction history record may indicate that the second account identifier was substituted for the first account identifier when generating the modified authorization request), and/or authorization system 602 may generate the modified authorization response for the payment transaction with the first account identifier included (e.g., in lieu of the second account identifier) based on identifying the transaction history record. In some non-limiting embodiments or aspects, authorization system 602 may communicate the modified authorization response, e.g., to an acquirer system and/or a payment gateway system (e.g., that initially communicated the authorization request).

With reference to FIG. 6B, in some non-limiting embodiments or aspects, acquirer system 610 may generate a settlement request message associated with the payment transaction. For example, the settlement request may be generated after a time period (e.g., predetermined time period, minimum time period, selected time period, and/or the like) after the authorization request message was initially communicated. In some non-limiting embodiments or aspects, the settlement request message may include the first account identifier (e.g., Lead Account). Additionally or alternatively, the settlement request may include other identifying information associated with the payment transaction, such as a transaction identifier, a timestamp, a merchant identifier, a merchant account identifier, any combination thereof, and/or the like. In some non-limiting embodiments or aspects, acquirer system 610 may communicate the settlement request message to settlement system 628.

In some non-limiting embodiments or aspects, settlement system 628 may receive the settlement request message associated with the payment transaction (e.g., from acquirer system 610). In some non-limiting embodiments or aspects, settlement system 628 and/or transaction history database 626 may identify the transaction history record based on the payment transaction. For example, settlement system 628 may receive (e.g., retrieve, request and receive, and/or the like) the transaction history record from transaction history database 626, and/or settlement system 628 may receive the second account identifier associated with the transaction history record from transaction history record from transaction history database 626.

In some non-limiting embodiments or aspects, settlement system 628 may generate a modified settlement request message. For example, settlement system 628 may generate a modified settlement request message based on identifying the transaction history record and/or receiving the second account identifier. In some non-limiting embodiments or aspects, the modified settlement request message may include the second account identifier. Additionally or alternatively, the modified settlement request may include other identifying information associated with the payment transaction, such as a transaction identifier, a timestamp, a merchant identifier, a merchant account identifier, any combination thereof, and/or the like.

In some non-limiting embodiments or aspects, settlement system 628 may communicate the modified settlement request message to the issuer system associated with the second account identifier (e.g., the one of the first issuer system 604a, the second issuer system 604b, and/or the third issuer system 604c based on which one of these issuer systems issued the second account identifier).

In some non-limiting embodiments or aspects, settlement system 628 may determine there is no transaction history record associated with the payment transaction stored in the transaction history database 626. In response to such a determination, settlement system 628 may apply a fallback settlement rule. For example, settlement system 628 may store and/or receive (e.g., from a settlement fallback rules database and/or the like) the fallback settlement rule.

In some non-limiting embodiments or aspects, the issuer system (e.g., one of issuer systems 604a, 604b, 604c) may generate a settlement response (e.g., a clearing message and/or the like) based on the modified settlement request message. For example, the settlement response may include the second account identifier.

In some non-limiting embodiments or aspects, settlement system 628 may receive the settlement response, e.g., from the issuer system. In some non-limiting embodiments or aspects, settlement system 628 may generate a modified settlement response, as described herein. For example, settlement system 628 may generate a modified settlement response for the payment transaction, and the modified settlement response may include the first account identifier. For example, settlement system 628 may identify the transaction history record stored in transaction history database 626 associated with the payment transaction (e.g., the transaction history record may indicate that the second account identifier was substituted for the first account identifier when generating the modified authorization request), and/or settlement system 628 may generate the modified settlement response for the payment transaction with the first account identifier included (e.g., in lieu of the second account identifier) based on identifying the transaction history record, as described herein. In some non-limiting embodiments or aspects, settlement system 628 may communicate the modified settlement response, e.g., to acquirer system 610 and/or a payment gateway system (e.g., that initially communicated the settlement request).

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A computer-implemented method, comprising:
receiving, with at least one processor, an authorization request message associated with a payment transaction, the authorization request message comprising a first account identifier associated with a user;
determining, with at least one processor, a second account identifier from a plurality of account identifiers based on at least one rule associated with the first account identifier;
generating, with at least one processor, a modified authorization request message for the payment transaction, the modified authorization request message comprising the second account identifier;
transmitting, with at least one processor, the modified authorization request message to an issuer system associated with the second account identifier; and
storing, with at least one processor, a transaction history record based on the payment transaction and the second account identifier.

2. The method of claim 1, further comprising:
receiving, with at least one processor, rule data associated with the at least one rule, wherein the rule data comprises a threshold value; and
determining, with at least one processor, whether a transaction amount of the payment transaction satisfies the threshold value,
wherein determining the second account identifier comprises selecting the second account identifier from the plurality of account identifiers based on the transaction amount satisfying the threshold value.

3. The method of claim 1, wherein the at least one rule comprises a first rule based on rule data received from the user and a fallback rule, wherein determining the second account identifier comprises:
determining, with at least one processor, the first rule is not applicable to the payment transaction associated with the authorization request message; and
in response to determining that the first rule is not applicable, determining, with at least one processor, the second account identifier from the plurality of account identifiers based on the fallback rule.

4. The method of claim 1 further comprising:
receiving, with at least one processor, a settlement request message associated with the payment transaction, the settlement request message comprising the first account identifier;
identifying, with at least one processor, the transaction history record based on the payment transaction;
generating, with at least one processor, a modified settlement request message based on identifying the transaction history record, the modified settlement request message comprising the second account identifier; and
transmitting, with at least one processor, the modified settlement request message to the issuer system associated with the second account identifier.

5. The method of claim 1, further comprising:
receiving, with at least one processor, a settlement request message associated with a second payment transaction, the settlement request message comprising the first account identifier;
determining, with at least one processor, a second transaction history associated with the second payment transaction is not stored; and
in response to determining the second transaction history is not stored, applying, with at least one processor, a fallback settlement rule.

6. The method of claim 1 further comprising:
receiving, with at least one processor, rule data associated with the at least one rule from the issuer system.

7. The method of claim 1, wherein the first account identifier comprises a lead account identifier associated with a physical payment device associated with the user, wherein the plurality of account identifiers comprises a plurality of virtual account identifiers associated with the user, wherein the second account identifier comprises a selected virtual account identifier, and wherein determining the second account identifier comprises selecting the selected virtual account identifier from the plurality of virtual account identifiers based on the at least one rule.

8. The method of claim 7, wherein the lead account identifier comprises a debit account identifier, and wherein the plurality of virtual account identifiers comprises a virtual credit account identifier and a virtual prepaid account identifier.

9. A system comprising:
at least one processor; and
at least one non-transitory computer-readable medium storing instructions that, when executed by the at least one processor, cause the at least one processor to:
receive an authorization request message associated with a payment transaction, the authorization request message comprising a first account identifier associated with a user;
determine a second account identifier from a plurality of account identifiers based on at least one rule associated with the first account identifier;
generate a modified authorization request message for the payment transaction, the modified authorization request message comprising the second account identifier;
transmit the modified authorization request message to an issuer system associated with the second account identifier; and
store a transaction history record based on the payment transaction and the second account identifier.

10. The system of claim 9, wherein the instructions, when executed by the at least one processor, further cause the at least one processor to:
receive rule data associated with the at least one rule, wherein the rule data comprises a threshold value; and
determine whether a transaction amount of the payment transaction satisfies the threshold value,
wherein determining the second account identifier comprises selecting the second account identifier from the plurality of account identifiers based on the transaction amount satisfying the threshold value.

11. The system of claim 9, wherein the at least one rule comprises a first rule based on rule data received from the user and a fallback rule, wherein determining the second account identifier comprises:
determining the first rule is not applicable to the payment transaction associated with the authorization request message; and
in response to determining that the first rule is not applicable, determining the second account identifier from the plurality of account identifiers based on the fallback rule.

12. The system of claim 9, wherein the instructions, when executed by the at least one processor, further cause the at least one processor to:
receive a settlement request message associated with the payment transaction, the settlement request message comprising the first account identifier;
identify the transaction history record based on the payment transaction;
generate a modified settlement request message based on identifying the transaction history record, the modified settlement request message comprising the second account identifier; and
transmit the modified settlement request message to the issuer system associated with the second account identifier.

13. The system of claim 9, wherein the instructions, when executed by the at least one processor, further cause the at least one processor to:
receive a settlement request message associated with a second payment transaction, the settlement request message comprising the first account identifier;
determine a second transaction history associated with the second payment transaction is not stored; and
in response to determining the second transaction history is not stored, apply a fallback settlement rule.

14. The system of claim 9, wherein the instructions, when executed by the at least one processor, further cause the at least one processor to:
receive rule data associated with the at least one rule from the issuer system.

15. The system of claim 9, wherein the first account identifier comprises a lead account identifier associated with a physical payment device associated with the user, wherein the plurality of account identifiers comprises a plurality of virtual account identifiers associated with the user, wherein the second account identifier comprises a selected virtual account identifier, and wherein determining the second account identifier comprises selecting the selected virtual account identifier from the plurality of virtual account identifiers based on the at least one rule.

16. The system of claim 15, wherein the lead account identifier comprises a debit account identifier, and wherein the plurality of virtual account identifiers comprises a virtual credit account identifier and a virtual prepaid account identifier.

17. A computer program product comprising at least one non-transitory computer-readable medium including program instructions that, when executed by at least one processor, cause the at least one processor to:
receive an authorization request message associated with a payment transaction, the authorization request message comprising a first account identifier associated with a user;
determine a second account identifier from a plurality of account identifiers based on at least one rule associated with the first account identifier;
generate a modified authorization request message for the payment transaction, the modified authorization request message comprising the second account identifier;
transmit the modified authorization request message to an issuer system associated with the second account identifier; and
store a transaction history record based on the payment transaction and the second account identifier.

18. The computer program product of claim 17, wherein the instructions, when executed by the at least one processor, further cause the at least one processor to:
receive rule data associated with the at least one rule, wherein the rule data comprises a threshold value; and
determine whether a transaction amount of the payment transaction satisfies the threshold value,
wherein determining the second account identifier comprises selecting the second account identifier from the plurality of account identifiers based on the transaction amount satisfying the threshold value.

19. The computer program product of claim 17, wherein the instructions, when executed by the at least one processor, further cause the at least one processor to:
receive a settlement request message associated with the payment transaction, the settlement request message comprising the first account identifier;
identify the transaction history record based on the payment transaction;
generate a modified settlement request message based on identifying the transaction history record, the modified settlement request message comprising the second account identifier; and
transmit the modified settlement request message to the issuer system associated with the second account identifier.

20. The computer program product of claim 17, wherein the first account identifier comprises a lead account identifier associated with a physical payment device associated with the user, wherein the plurality of account identifiers comprises a plurality of virtual account identifiers associated with the user, wherein the second account identifier comprises a selected virtual account identifier, and wherein determining the second account identifier comprises selecting the selected virtual account identifier from the plurality of virtual account identifiers based on the at least one rule, and
wherein the lead account identifier comprises a debit account identifier, and wherein the plurality of virtual account identifiers comprises a virtual credit account identifier and a virtual prepaid account identifier.
